(19) United States
(12) Patent Application Publication
(10) Pub. No.: US 2007/0005235 A1
(43) Pub. Date: Jan. 4, 2007

(54) Navigation system

(75) Inventors: Takamitsu Suzuki, Okazaki-city (JP); Masanori Oumi, Gifu-city (JP); Hirotoshi Iwasaki, Tokyo (JP); Nobuhiro Mizuno, Tokyo (JP); Kosuke Hara, Tokyo (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); DENSO IT LABORATORY, INC., Tokyo (JP)

(21) Appl. No.: 11/475,083

(22) Filed: Jun. 27, 2006

(30) Foreign Application Priority Data
Jul. 1, 2005 (JP) 2005-194104

(51) Int. Cl. G01C 21/00

(52) U.S. Cl. 701/200; 701/201

(57) ABSTRACT

A navigation system having a travel situation detection function for providing a navigation route of a travel between a start point and an end point includes a storage unit and an inference engine. The storage unit stores a travel purpose determiner that suitably determines a travel purpose according to a travel situation of a predetermined type having time specificity, and the inference engine infers the end point of the travel based on the travel purpose that results from an application of a detected travel situation by the travel situation detection function to the travel purpose determiner.

### CROSS REFERENCE TO RELATED APPLICATION

This application is based on and claims the benefit of priority of Japanese Patent Application No. 2005-194104 filed on Jul. 1, 2005, the disclosure of which is incorporated herein by reference.

### FIELD OF THE INVENTION

The present invention generally relates to a navigation system for use in a vehicle.

### BACKGROUND OF THE INVENTION

A conventional navigation system used in a vehicle typically determines a navigation route toward an inputted destination of a travel for navigating a user/driver of the vehicle. In addition, the conventional navigation system is capable of finding a detour or alerting the driver when the original navigation route has a traffic jam en route to the destination.

The navigation route usually accepts an input from the user for specifying the destination of the travel. On the other hand, the user does not necessarily input the destination of the travel when, for example, the travel to the destination only takes five minutes on a well-trod route. In other words, the user does not feel it worthwhile to input the destination for an easy route.

The navigation system is also capable of automatically assuming a destination of a travel when the user does not input the destination of the travel. The navigation system having a destination estimation function determines the navigation route to the destination based on estimation of the destination candidates. The navigation system disclosed in Japanese Patent Document JP-A-H7-83678 is, for example, capable of assuming the destination and determining the navigation route toward the destination based on the estimation.

The navigation system in the above disclosure estimates plural destination candidates of the travel based on the travel history of the vehicle, and determines a single destination estimation from among the plural destination candidates based on, for example, calculation of travel frequency of a currently traveled route that led to one of the destination candidates.

The navigation system in the above disclosure also determines the destination estimation of the travel based on the time slot of the travel identified by the date of the month and the day of the week beside employing the information on the currently traveled route. Further, the navigation system in the above disclosure is described as being capable of calculating an alternative navigation route for avoiding an expected traffic congestion en route to the destination based on the destination estimation.

However, the travel of the vehicle in the same time slot of the day on the same day of the week by following the same navigation route may lead to a different destination depending on the situation or the purpose of the travel. For example, the travel for the purpose of, e.g., either of a shopping or a work, may result in having an altered destination of the travel even when the travel of the vehicle takes place on the same day of the week and in the same time slot of the day. In this manner, the navigation system in the above disclosure has a problem that the purpose of the travel is not considered and reflected on the estimation of the travel destination.

Further, the navigation system for various target devices/machines including a portable device or similar type encounters the same problem when the method of estimation of the travel destination is the same.

### SUMMARY OF THE INVENTION

In view of the above-described and other problems, the present disclosure provides a navigation system that prepares a destination estimation for serving a user.

The navigation system for providing a navigation route of a travel between a start point and an end point includes a storage unit for storing a travel purpose determiner that suitably determines a travel purpose according to a travel situation of predetermined type having time specificity and an inference engine for inferring the end point of the travel based on the travel purpose that results from an application of an actually detected travel situation to the travel purpose determiner.

The navigation system estimates the destination of the travel without having a destination input from the user based on the travel situation used for travel purpose estimation. That is, the travel situation of a currently detected travel is identified based on travel information such as the day of the week and the time slot of the day, and is used to inferentially determine a purpose of the current travel by using a travel purpose determiner stored in the storage unit. Then, the inferred travel purpose is applied to the inference engine for inferentially determining the end point, i.e., a destination of the current travel. In this manner, the purpose of the travel is employed for accurately determining the destination of the travel based on the detected travel situation.

In another aspect of the present disclosure, the navigation system employs user information for travel purpose determination. The travel purpose is more accurately determined when the user information is used for destination estimation.

In yet another aspect of the present disclosure, the navigation system employs Bayesian network model for destination estimation. That is, the travel purpose determiner in the storage unit is represented by Bayesian network model where a travel situation node and a user information node as parent nodes of a travel purpose node. The travel purpose determiner may also be represented by a neural network model, a support vector machine, a fuzzy inference, a cooperative filtering or the like.

Further, the inferential relationship between the travel purpose and the destination of the travel may be represented by employing various relationship models. In addition, the inference of the destination and the travel purpose may be defined as an integration of two separate relationships as well as two separate relationships. That is, the two relationships between the travel situation and the travel purpose and between the travel purpose and the destination of the travel may be integrally represented as a single relationship between the travel situation and the destination of the travel.

Furthermore, the relationship represented by the Bayesian network model is redefined or improved based on the determined destination by reversing the inference relationship of the travel purpose to the destination. The destination and the travel purpose as well as the travel situation and the user information are used for inductively redefining the Bayesian network model.

In still yet another aspect of the present disclosure, the inference engine outputs the travel purpose determined by the destination of the travel. In this manner, the user of the navigation system can confirm the relationship between the travel purpose and the destination, thereby understanding the reasoning of the inference by the navigation system.

In still yet another aspect of the present disclosure, the destination estimation by the navigation system may be based on a plurality of the destination candidates with navigation routes toward the destination candidates and the current position of the vehicle. In this manner, the destination of the travel is more accurately determined based on the inferential reasoning.

In still yet another aspect of the present disclosure, the navigation system may output information on the travel purpose determined by the travel purpose determiner. For example, the information on the travel purpose may include facility information for fulfilling the same purpose, business day of the facility and the like. In this manner, the user may be able to select a better destination than the previously visited destination, or may be able to recognized the holiday of the facility before arriving at the destination.

In still yet another aspect of the present disclosure, the navigation system may be functional for storing a program for providing the function of the travel purpose determiner and for providing the function of the inference engine. The navigation system may be used in, for example, an automotive vehicle, and the storage of the program may include, for example, a hard disk drive in the vehicle, a portable device for use in and out of the vehicle. The storage of the program may also include a device in a server of a network.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a car navigation system in an embodiment of the present disclosure;

FIG. 2 shows a block diagram of functions in a control unit of the navigation system in FIG. 1;

FIG. 3 shows an illustration of Bayesian network model in a user model storage unit in FIG. 2;

FIG. 4 shows a robustness diagram of functions in the control unit in FIG. 2;

FIG. 5 shows a flowchart of a process for storing user information in a memory in FIG. 2;

FIG. 6 shows a flowchart of a process for route search based on the user information and travel situation;

FIG. 7 shows a flowchart of a process for re-definition of the Bayesian network model;

FIG. 8 shows an illustration of another Bayesian network model;

FIG. 9 shows a flowchart of a partial process for controlling a detour display for use in the process in FIG. 6;

FIG. 10 shows a flowchart of a partial process for use in the process in FIG. 6;

FIG. 11 shows an illustration of a common route among a plurality of navigation route candidates; and

FIG. 12 shows a flowchart of a process for controlling information display regarding a travel purpose.

### DETAILED DESCRIPTION OF THE PREFERRED EMBODIMENTS

Embodiments of the present disclosure are described with reference to the drawings. Like parts have like numbers in each of the embodiments.

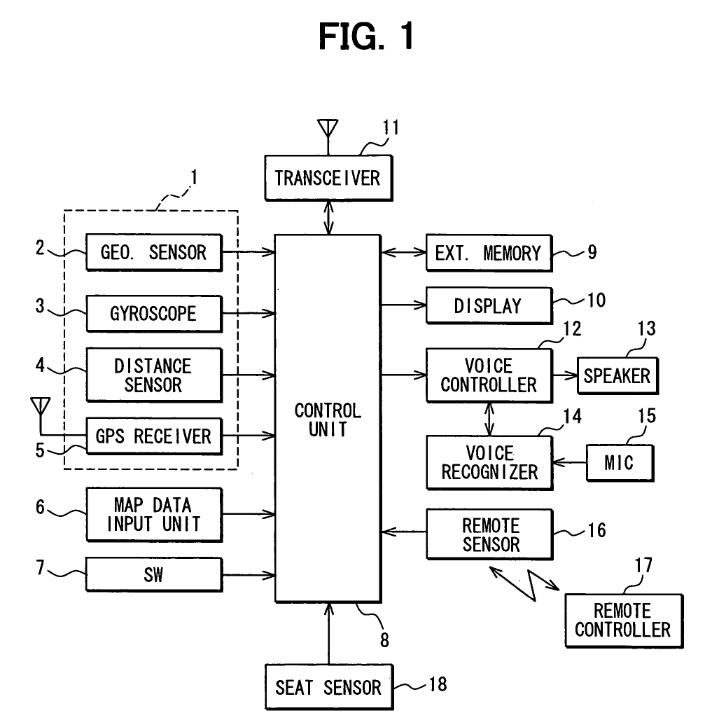

FIG. 1 shows a block diagram of a car navigation system in an embodiment of the present disclosure. The navigation system includes a position detector 1, a map data input unit 6, operation switches 7, an external memory 9, a display 10, a transceiver 11, a voice controller 12, a speaker 13, a voice recognizer 14, a microphone 15, a remote controller sensor 16, a remote controller 17, a seat sensor 18 and a control unit 8. The control unit 8 controls the above-described devices connected thereto.

The control unit 8 is a well-known type computer that includes a CPU, a ROM, a RAM, an I/O and a bus line for connecting those components. The ROM stores a program that is executed by the control unit 8, and the CPU controlled by the stored program processes predetermined calculations and other procedures.

The position detector 1 includes a plurality of well-known type sensors such as a geomagnetism sensor 2, a gyroscope 3, a distance sensor 4, and a Global Positioning System (GPS) receiver 5. The geomagnetism sensor 2 is used to detect a magnetic direction of a vehicle, and the gyroscope 3 is used to detect a relative bearing of the vehicle. The distance sensor 4 is used to detect a travel distance of the vehicle, and the GPS receiver 5 receives a radio wave from a GPS satellite for detecting a position of the vehicle. These sensors and/or receivers can compensate respectively different characteristics of inherent errors by interacting complementarily with each other. These sensors and/or receivers may selectively be used based on the accuracy of the output, and a steering rotation sensor, a speed sensor or the like (not shown in the figure) may additionally be utilized.

The map data input unit 6 is used to input digital map data such as road data, background drawing data, text data, facility data and the like. These data are provided by a memory medium such as a DVD-ROM, a CD-ROM. The map data input unit 6 retrieves these data to the control unit 8 by using a DVD-ROM drive, a CD-ROM drive or the like (not shown in the figure) connected thereto.

The operation switches 7 are disposed on, for example, the display 10 as touch switches, mechanical switches or the like, and are used for inputting various kinds of instructions for controlling road map on the display 10. That is, the road map control instructions include a map scale change instruction, a menu selection instruction, a destination setting instruction, a navigation start instruction, a current position correction instruction, a screen change instruction, a volume control instruction and the like.

The remote controller 17 has a plurality of switches (not shown in the figure) for inputting the same kind of instructions as the instructions from the operation switches 7. The remote controller 17 outputs control signals of instructions, and the control signals are provided for the control unit 8 through the remote controller sensor 16.

The external memory 9 is a memory medium, e.g., a memory card, a hard disk or the like, with read/write capability for storing data and/or information such as text data, image data, sound data as well as user information, e.g., a location of user's home and the like. The external memory 9 in the present disclosure stores five entries of fixed search conditions for use in the route search for a travel between a start point and a destination (an end point).

The fixed search condition is a set of plural weight coefficients for weighting the road attributes in the link data retrieved from the map data input unit 6.

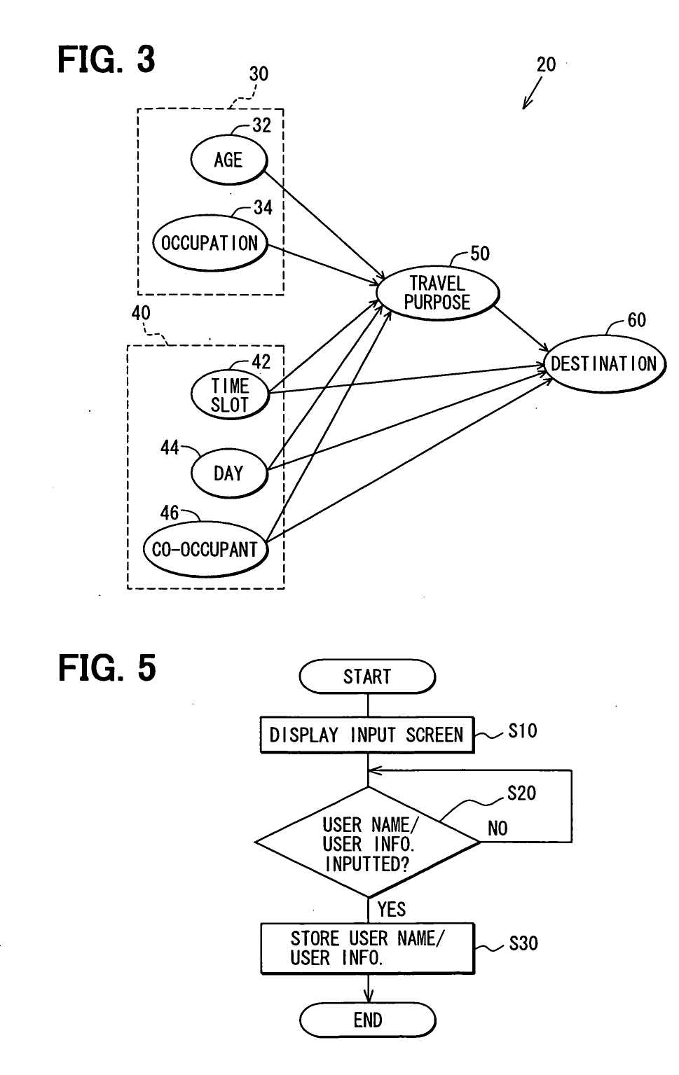

The user model storage unit 9a stores Bayesian network model 20 for defining a travel purpose determiner illustrated in FIG. 3. The Bayesian network model 20 in FIG. 3 includes user information node 30 for representation of user information, travel situation node 40 for representation of travel situation, travel purpose node 50 for representation of travel purpose, and destination node 60 for representation of the destination of the travel. The user information 30 includes two nodes, that is, an age node 32 and an occupation node 34. The travel situation node 40 includes three nodes, that is, a time node 42, a day node 44 and an occupant node 46.

The age node 32 transits between plural states by having a natural number for representing an age of a driver/user. The occupation node 34 transits between plural states by having a predetermined type occupation for representing the occupation of the driver. The time node 42 transits between plural states for representing a time slot of travel allocated in 24 hours of the day. The time slot of the time node 42 may have, for example, a period of four hours, two hours, one hour or the like. The day node 44 transits between seven states for representing the day of the week. The occupant node 46 transits between two nodes for representing a co-occupant of the vehicle other than the driver of the vehicle. The above-described nodes 32, 34, 42 44, 46 are observation parameters.

The travel purpose node 50 is used to represent a predetermined type travel purpose by having a state of, for example, shopping, commuting and the like. The travel purpose node 50 is a hidden node, and the age node 32, the occupation node 34, the time node 42, the day node 44, the occupant node 46 are defined as parent nodes of the travel purpose node 50.

The destination node 60 represents a predetermined type destination by transiting between plural states of destination candidate. The plural states of destination candidate is provided by learning from actual travels and initial settings. The destination node 60 is defined as a child node of the travel purpose node 50, the time node 42, the day node 44, and the occupant node 46.

The parent node and the child node are connected by an arrow, and the arrow represents a conditional dependency between the parent node on a start point side of the arrow and the child node on an end point side of the arrow by defining the probability of the conditional dependency.

The Bayesian network model 20 defined in the above-described manner is used to determine the probability of each node included in the travel purpose node 50, and the probability of each of the destination candidate in the destination node 60 is determined based on the probability of the travel purpose node 50.

The learning data storage unit 9b stores the learning data for re-defining or re-organizing the Bayesian network model 20. The learning data are the data that are inputted to the Bayesian network model 20 when the destination candidate is estimated. That is, the learning data is a set of information of the age of the driver, the occupation of the driver, the time of the day of the travel, the day of the week of the travel, the co-occupant of the vehicle and stop locations of the travel.

The cost evaluation function storage unit 9c stores a cost evaluation function Ci for use in a route search. The cost evaluation function Ci is represented in a form of an equation 1. The elements in the equation 1 include a distance cost I(i), an average travel time cost t(i), a route width cost w(i), and a turn cost n(i). The elements have weighting coefficients of α, β, λ and δ.
Ci=αI(i)+βt(i)+γw(i)+δn(i) Equation 1

The equation 1 represents an example of the cost evaluation function Ci. The cost evaluation function Ci may include other parameter elements such as a speed limit, the number of traffic signals or the like.

The user information storage unit 9d stores user information such as a birth date, an occupation for identifying the user among the plural entries of the users. The user entries are stored in association with user names. The periodically changing user information such as the age of the user may be used for identifying the user because the birth date of the user can be employed for calculating the age of the user at the time of the travel. In this manner, the periodically changing information as well as the fixed information may be included in the user information for identifying the user. For example, information on an annual user income may be included in the user information as it is expected to change only once in a year.

The display 10 is, for example, a liquid crystal display, an organic EL display or the like, and displays a position mark of the vehicle at a current position in a map display area of the display 10 on top of the road map generated by using the map data. The display 10 also displays other information such as a current time, traffic congestion information or the like in addition to the vehicle position and the road map.

The transceiver 11 is a communication device for providing communication with external information sources for the control unit 8. For example, traffic information, weather information, date information, facility information and advertisement information are received from external information resources by using the transceiver 11. The information may be outputted from the transceiver 11 after processing in the control unit 8.

The speaker 13 is used to output a predetermined sequence of sound such as navigation guidance voice, screen operation guidance voice, voice recognition result or the like based on a sound output signal from the voice controller 12.

The microphone 15 converts user's voice to an electric signal that can be inputted to the voice recognizer 14. The voice recognizer 14 recognizes the inputted user's voice for comparison with vocabulary data in an internal dictionary (not shown in the figure), and outputs a recognition result to the voice controller 12 based on the resemblance of the user's voice to the stored vocabulary data.

The voice controller 12 controls the voice recognizer 14, and gives response to the user by talking back from the speaker 13. The voice controller 12 also controls the input of the recognition result by the voice recognizer 14 to the control unit 8.

The seat sensor 18 detects an occupant in each of the seat in the vehicle for outputting an occupant signal for representing the existence of the occupant to the control unit 8.

The control unit 8 executes a predetermined process in response to the user's voice based on the recognition result of the voice recognizer 14, or in response to the user input from the operation switches 7 or from the remote controller 17. The predetermine process includes, for example, a map data storage process for storing the map data in the external memory 9, a map scale change process, a menu selection process, a destination setting process, a route search execution process, a route navigation process, a current position correction process, a display screen change process, a volume control process and the like. Further, route navigation guidance information or the like processed in the control unit 8 is provided for the user in a suitable manner from the speaker 13 under control of the voice controller 12. The destination setting process automatically estimates the destination of the travel when the user or the occupant of the vehicle does not execute the destination input operation.

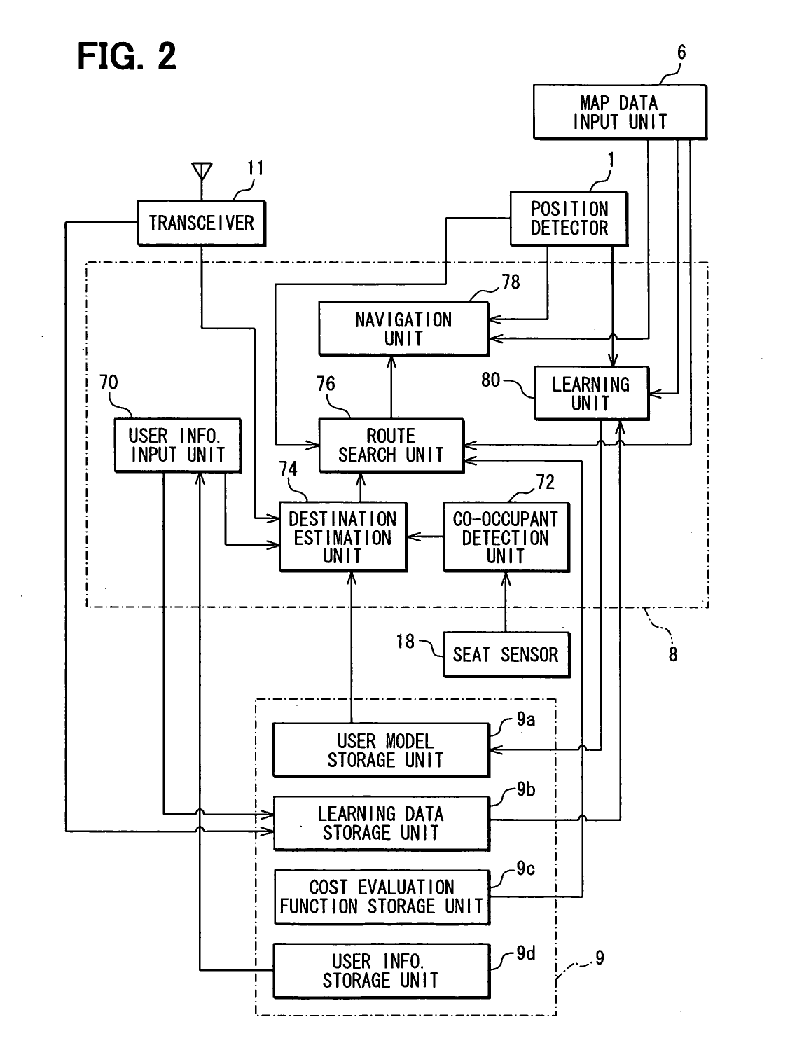

FIG. 2 shows a block diagram of functions in a control unit 8 of the navigation system in FIG. 1. The control unit 8 includes a user information input unit 70, a co-occupant detection unit 72, a destination estimation unit 74, a route search unit 76, a navigation unit 78 and a learning unit 80.

The user information input unit 70 determines the driver of the vehicle and receives user information of the driver from the user information storage unit 9d of the external memory 9. In this case, the user information includes the birth date of the driver and the occupation of the driver. The age of the driver is calculated based on the birth date. The information about who the driver is is determined by displaying a list of predetermined entries on the display 10 and by selecting one of the entries based on an input of the driver from the operation switches 7 or from the remote controller 17.

The co-occupant detection unit 72 detects the co-occupant of the vehicle beside the driver based on the signal from the seat sensor 18. The information on the co-occupant is regarded as a part of the travel situation.

The destination estimation unit 74 determines the probability of each of the purpose nodes in the destination node 50 based on the age, the occupation, the time slot, the day of the week and the co-occupant respectively derived from the user information input unit 70, a clock in the vehicle, the transceiver 11 and the seat sensor 18. Then, the derived information determines the age node 32, the occupation node 34, the time node 42, the day node 44, the occupant node 46 in the Bayesian network model 20 for determining the probability. Further, the probability of each of the destination candidates is determined based on the probability of the each of the travel purposes in the travel purpose node 50 in addition to the state of the time node 42, the day node 44 and the occupant node 46. Then, the destination candidate having the highest probability is established as the estimated destination of the travel. The destination estimation unit 74 estimates the destination when the driver of the vehicle does not input the destination. The destination estimation unit 74 may be used for estimating a stop-by place en route to the destination when the destination is determined by the driver or the user.

The route search unit 76 determines a navigation route from a start point (a current position of the vehicle) to the destination (an end point) estimated by the destination estimation unit 74 based on the cost evaluation function Ci in the storage unit 9c and the map data inputted from the map data input unit 6. The route search by the route search unit 76 employs a well-known method such as Dijkstra method or the like for finding the navigation route that is characterized by a minimum value of the cost evaluation function Ci in the equation 1.

The navigation unit 78 provides route navigation toward the destination based on the navigation route determined by the route search unit 76, the current position of the vehicle detected by the position detector 1 and the map data inputted from the map data input unit 6.

The learning unit 80 conducts learning process for re-defining and updating the Bayesian network model 20 based on the destination, the travel situation and the user information after the determination of the destination. The destination of the travel is determined based on one of the stop location of the vehicle and the user input of the destination. The stop location is determined as the destination when the destination is estimated by the destination estimation unit 74, and the inputted destination is determined as the destination when an user input for specifying the destination is detected. The learning process of the Bayesian network model 20 based on the stop location is executed when stopping of the vehicle in the travel after destination estimation is detected. The learning process based on the stop location uses the stop location of the vehicle in addition to the travel situation and the user information inputted to the Bayesian network model 20. The learning process may not necessarily be executed just after the arrival to the destination, and may be executed after a predetermined cycle of the learning process. The learning process may also be executed before arriving at the destination when the destination is being specified by the user input.

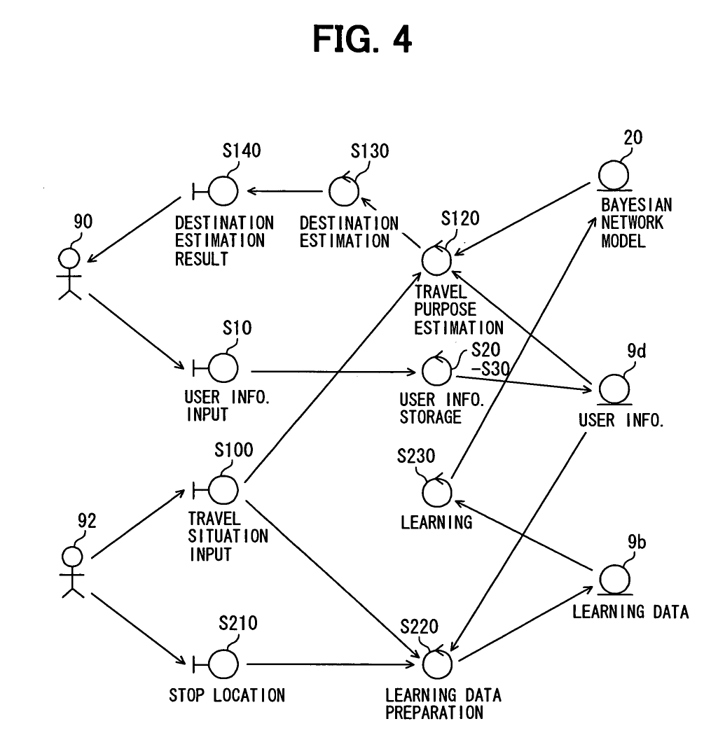

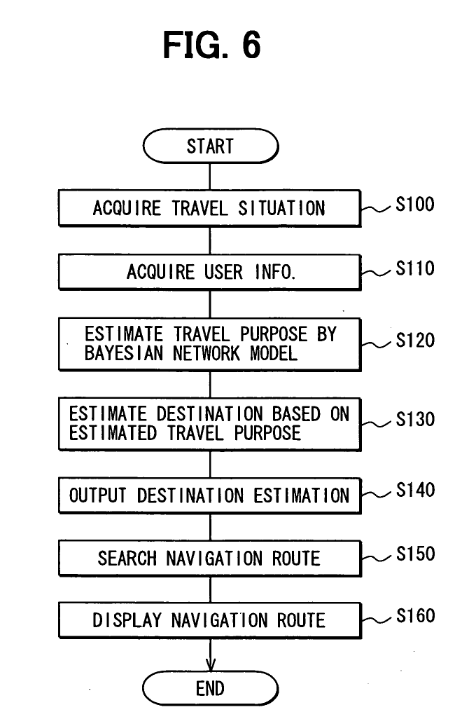

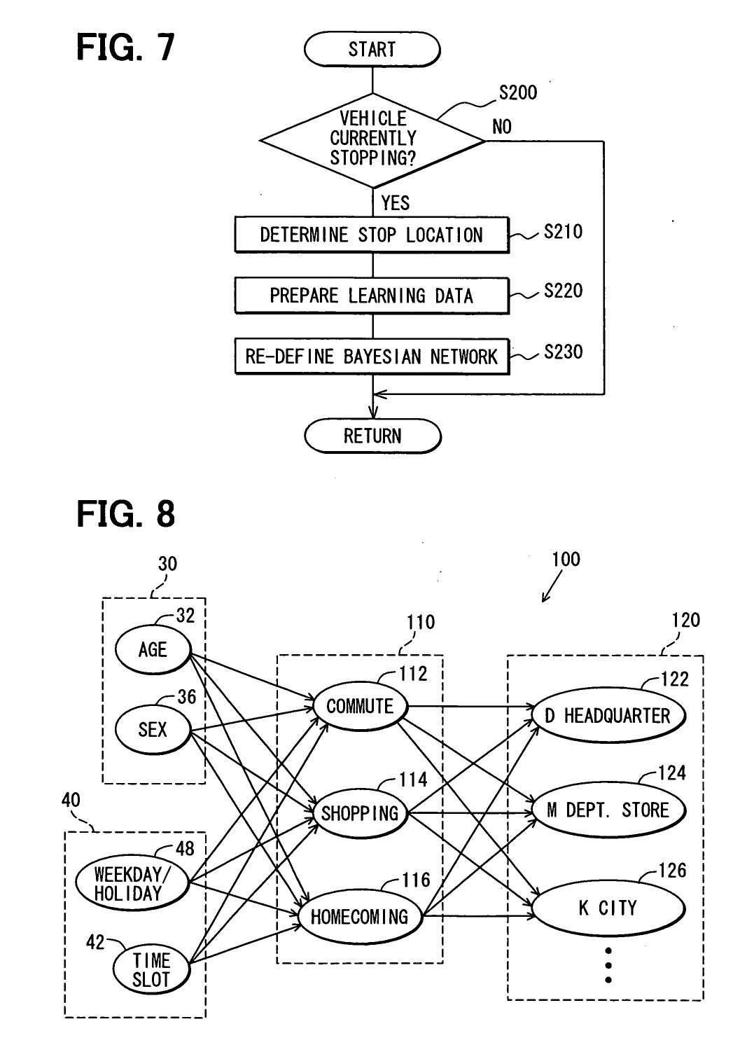

FIG. 4 shows a robustness diagram of the function of the control unit 8. The user is represented as an icon 90 in the diagram, and the transceiver 11 and the co-occupant detection unit 72 are represented as an icon 92. The other numerals such as step numbers or the like are used in flowcharts in FIG. 5, FIG. 6 and FIG. 7.

FIG. 5 shows a flowchart of a process for storing the user information in the external memory 9 in FIG. 2.

In step S10, the process displays an input screen for the input of the user name, the user information and the information for calculating/determining the user, i.e., the birth date and the occupation on the display 10.

In step S20, the process determines whether the user name, the birth date and the occupation are inputted. The process proceeds to step S30 when the input is complete (step S20:YES). The process repeats step S20 when the input is not complete (step S20:NO).

In step S30, the process stores the user name and other information inputted in step S20 in the user information storage unit 9d of the external memory 9.

FIG. 6 shows a flowchart of a process for route search based on the user information and the travel situation.

In step S100, the process acquires the travel situation such as the existence of the co-occupant and the like. The function of the co-occupant detection unit 72 corresponds to the process in step S100. The existence of the co-occupant is detected based on the signal from the seat sensor 18, and the day of the week is acquired through the information from the transceiver 11. The time slot of the travel is determined based on the signal from the clock in the vehicle. The time slot, the day of the week, and the co-occupant information are stored in the learning data storage unit 9b.

In step S110, the process acquires the user information by displaying entries in the user list on the display 10 and receiving the input for specifying the user. The function of the user information input unit 70 corresponds to the process in step S110. The user information specified by using the operation switches 7 or by the operation on the remote controller 17 is used for retrieving the birth date and the occupation of the user from the user information storage unit 9d. Then, the age of the user is determined based on the birth date and the time signal from the clock acquired in step S100. Then, the age and the occupation of the user are stored in the learning data storage unit 9b.

In steps S120 to S140, the process executed in the control unit 8 serves as the function of the destination estimation unit 74. In step S120, the process calculates the probability of each of the purpose nodes in the travel purpose node 50 based on the input of the travel situation (the time slot, the day of the week and the co-occupant) and the user information (the age and the occupation) into the Bayesian network model 20 stored in the user model storage unit 9a of the external memory 9.

In step S130, the process calculates the probability of each of the destination candidates in the destination node 60 based on the probabilities of the purpose nodes and the travel situation. The destination candidate having the highest probability is determined as the estimated destination.

In step S140, the process displays the estimated destination on the display 10.

In steps S150 to S160, the process executed in the control unit 8 serves as the function of the route search unit 76. In step S150, the process searches for the navigation route to the destination from the current vehicle position vehicle detected by the position detector 1. The searched route has the minimum evaluation cost derived from the cost evaluation function Ci by employing Dijkstra method or the like.

In step S160, the process displays the navigation route searched in step S150 on the display 10.

Now, the process for re-defining and updating the Bayesian network model 20 is described.

FIG. 7 shows a flowchart of a process for re-definition of the Bayesian network model 20. The process shown in FIG. 7 corresponds to the function of the learning unit 80, and the process in FIG. 7 repeats itself during the travel after destination estimation.

In step S200, the process determines whether the vehicle is stopping. The stopping of the vehicle is detected based on the current vehicle position from the position detector 1. The stopping of the vehicle may also detected based on an ON/OFF condition of an ignition key. The process proceeds to step S210 when the vehicle is determined as stopping, and the process concludes itself when the vehicle is determined as not stopping.

In step S210, the process determines the current position of the vehicle derived from the position detector 1 as the stop location of the vehicle, and stores the stop location in the learning data storage unit 9b.

In step S220, the process prepares the learning data for re-defining the Bayesian network model 20. The learning data includes the state of each of the nodes in the Bayesian network model 20, that is, the states of the nodes 32, 34, 42, 44, 46, 50, 60. The states of the age node 32 and the occupation node 34 are stored the process in step S110 shown in FIG. 6, the states of the time node 42, the day node 44 and the co-occupant node 46 are stored in the process in step S100 shown in FIG. 6 in the learning data storage unit 9b. The destination node 60 is represented by the stop location stored the process in step S210.

The travel purpose node 50 is determined in the following manner. That is, the stop location determined in step S210 and facility data in the map data are employed for determining a facility type in the destination. Then, a predetermined relationship between the facility type and the travel purpose is employed for determining the travel purpose based on the stop location and the facility type determined above. In this manner, the trave purpose is determined, for example, as shopping when the stop location is a shopping center. In this case, the facility type may be associated with a plurality of travel purposes depending on the situation. For example, the facility type of a station is associated with two purposes such as commuting and pick-up/drop-off. When the stop location determined in step S210 has the facility type attribute in association with plural purposes, the plural purposes are presented to the user by using the display screen or the guidance voice for allowing the user to select a single purpose.

In step S230, the process re-defines the probability of conditional dependencies between the parent nodes and the child nodes store in the user model storage unit 9a based on the learning data prepared in step S220. The re-definition process repeated in plural times improves the accuracy of destination estimation and purpose estimation.

The navigation system of the present disclosure determines the estimated destination based on two step inference of a primary estimation of the travel purpose based on the travel situation and a succeeding estimation of the destination based on the estimated travel purpose when destination of the travel is not specified by the user. In this manner, the destination of the travel is accurately estimated based on the employment of the travel purpose.

Further, the travel situation including the co-occupant information in addition to the time slot and the day of the week improves the accuracy of the destination estimation. Furthermore, the user information is employed for increased accuracy of the destination estimation.

The improvement on the accuracy of the destination estimation yields a pervasive effect of, for example, provision of the navigation route for improved fuel efficiency and provision of the navigation route having improved drivability by predicting right/left turns in the extended span of the navigation route.

Furthermore, the effect of the present disclosure may be utilized in regenerating braking in a hybrid-engine vehicle. More practically, a hybrid type engine in the hybrid vehicle may be able to decrease the use of a gasoline engine for the purpose of recharging a secondary battery based on an accurate prediction of a downward slope in an estimated navigation route in the proximity of the current position for recharging by the regenerating braking by an electric motor.

Although the present disclosure has been fully described in connection with the preferred embodiment thereof with reference to the accompanying drawings, it is to be noted that various changes and modifications will become apparent to those skilled in the art.

For example, the Bayesian network model 20 is replaced with a different type Bayesian network model 100 shown in FIG. 8.

The Bayesian network model 100 includes the user information node 30 having two nodes, that is, an age node 32 and a sex node 36. The age node 32 represents user age, and the sex node 36 represents a distinction between male and female regarding the sex of the user. The Bayesian network model 100 also includes the travel situation node 40 that has a time slot node 42 and a day node 48. The time slot node 42 represents the time slot of the travel, and the day node 48 represents a distinction of a workday and a holiday regarding the day of the week. Further, a travel purpose node 110 included in the Bayesian network model 100 has a commute node 112, a shopping node 114 and a homecoming node 116. Furthermore, a destination node 120 included in the Bayesian network model 100 has a D headquarter node 122, an M department store node 124 and a K city node. The commute node 112, the shopping node 114 and the homecoming node 116 in the travel purpose node 110, and the D headquarter node 122, an M department store node 124 and a K city node in the destination node 120 respectively take plural probability values. In the Bayesian network model 100 shown in FIG. 8, the travel purpose node 110 is defined as an only parent node of the destination node 120. In this case, when the destination estimation based only on the travel purpose is determined to accurate enough, i.e., the probability of the destination is greater than a predetermined value, the navigation system may provide guidance about other facility that serves as the destination of the same travel purpose.

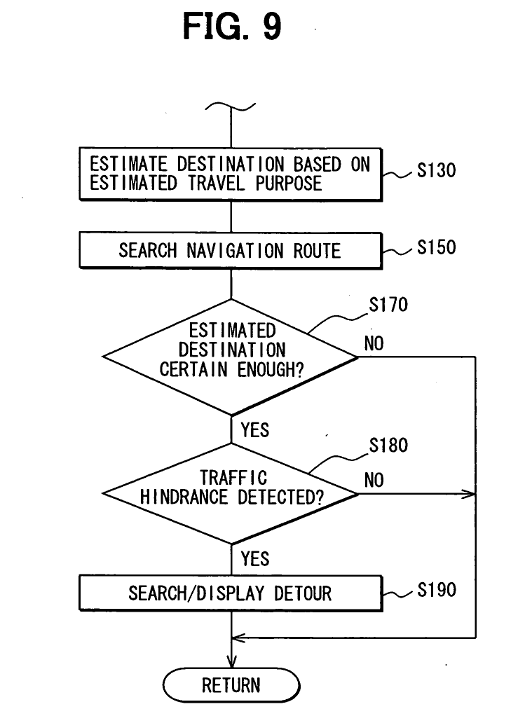

In the embodiment described above, the navigation system displays the estimated destination and the navigation route thereto. However, the navigation system may display a detour of the navigation route originally calculated for the estimated destination. The user who does not input the destination to the navigation system may be familiar with the current destination and the navigation route to the current destination, thereby in demand only for the detour of an optimum navigation route as shown in a flowchart in FIG. 9. The navigation system repeats the process in the flowchart in FIG. 9 at a predetermined interval while the vehicle is traveling to the destination.

A part of the process shown in FIG. 9 is same as the process in the flowchart in FIG. 6. That is, steps of the process before step S130 in FIG. 9is same as steps of the process before step S130 in FIG. 6, and step S150 for route search after step S130 in FIG. 9 is identical to step S150 in FIG. 6.

In step S170, the process determines whether the probability of the destination candidate calculated in step S130 is greater than a predetermined value. The process proceeds to step S180 when the probability is greater than the predetermined value (step S170:YES). The process concludes itself when the probability is not greater than the predetermined value (step S170:NO). In this manner, the certainty of the estimated destination is determined by the process.

In step S180, the process determines whether the navigation route to the estimated destination has traffic hindrance based on traffic information received by the transceiver 11. The process proceeds to step S190 when the traffic hindrance is detected (step S180:YES). The process concludes itself when the traffic hindrance is not detected (step S180:NO).

In step S190, the process searches and displays a detour route of the optimum or originally calculated navigation route. The detour route display may be replaced with provision of a warning.

Another modification of the embodiment may include a different set of nodes in the travel situation node of the Bayesian network model. That is, the travel situation reflected in the Bayesian network model 20 may include the weather, the traffic congestion condition, the current vehicle position, the amount of money currently in the purse or the like besides the time slot and the weekday/holiday distinction.

Also, the user information may include the age group of the user, the hometown, the home address, the number of family member, the number of housemate or the like besides the age, the occupation and the sex of the user.

Furthermore, the user may be identified based on an input of the identity by the user him/herself, or based on the image recognition, voice recognition, or similar type recognition method instead of selecting one of the user entries in the user list.

Furthermore, the estimated destination may be announce by voice when an expected stop-by place is identical to the estimated destination.

Furthermore, travel history of the vehicle may be employed for destination estimation.

Furthermore, determination of the estimated destination may be postponed until the current position of the vehicle approaches the estimated destination. That is, two or more estimated destinations having almost same probabilities may be kept undetermined as the destination for display on the screen until the position of the traveling vehicle further approaches the destination.

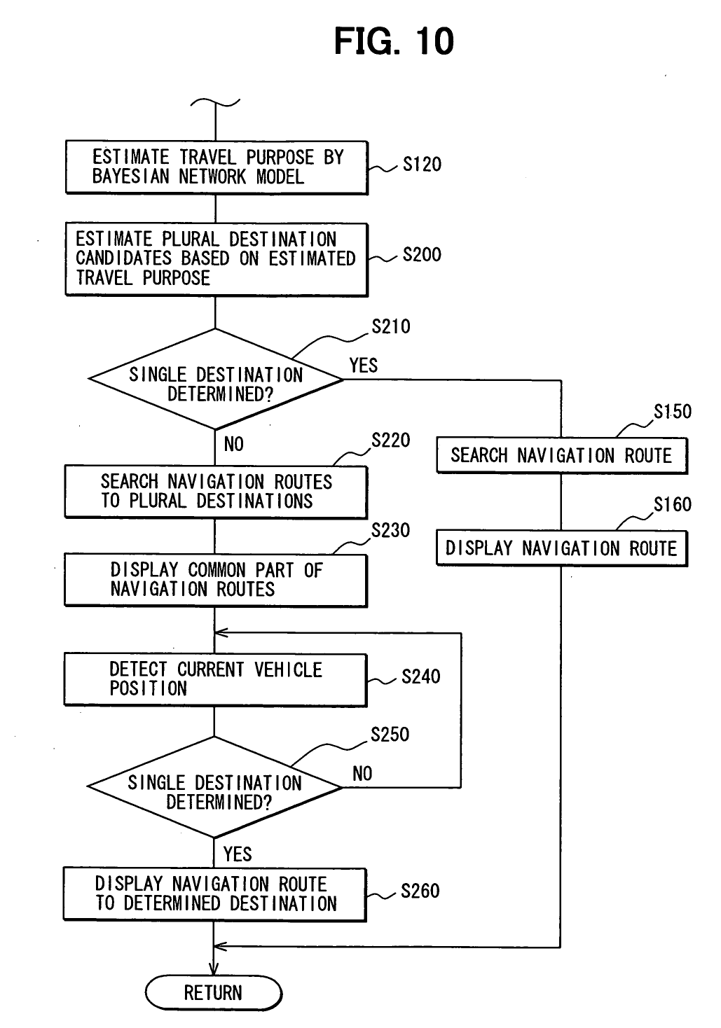

FIG. 10 shows a flowchart of the process for the above-described situation. In steps S100 to S120 originally shown in FIG. 6, the process calculates the probabilities of the nodes in the travel purpose node 50 of the Bayesian network model 20 based on the travel situation and the user information.

In step S200, the process determines the probability for each of the destinations represented in the destination node 60. In this case, a predetermined number of destinations having the higher probabilities are selected as destination candidate.

In step S210, the process determines whether a single destination can be distinctively selected. That is, the process determines the single destination candidate having the highest probability with a predetermined probability difference to the second candidate. The process proceeds to steps S150 and S160 for route search and route display when the single destination is distinctively determined (step S210:YES). The process proceeds to step S220 when the single destination is not determined (step S210:NO).

In step S220, the process searches and calculates navigation routes for each of the plural destination candidates.

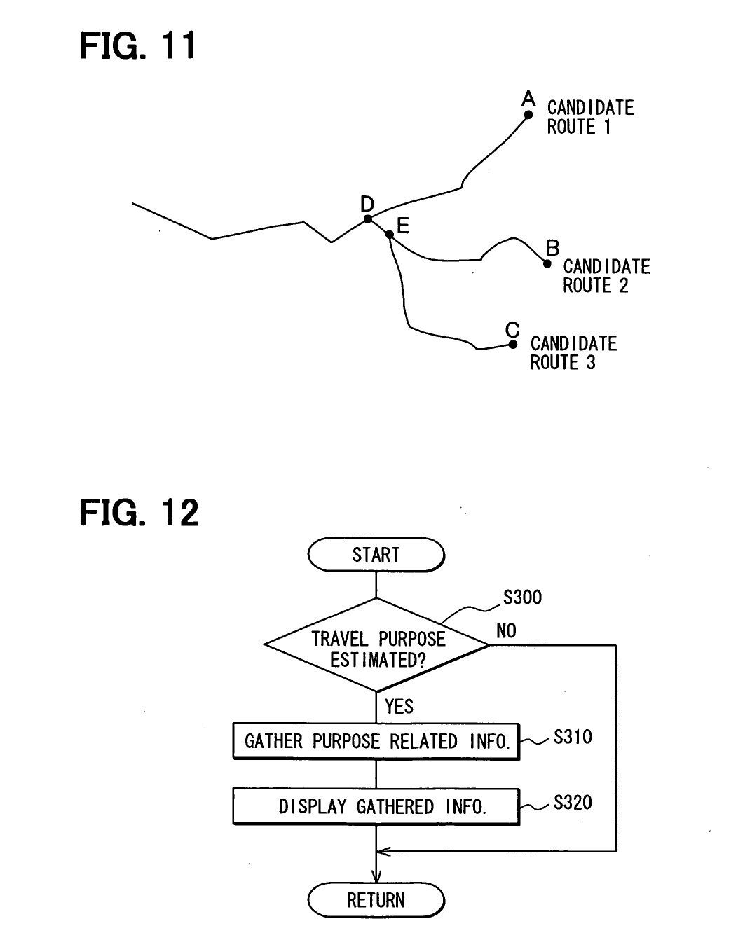

In step S230, the process displays a common part of the plural navigation routes on the display 10. For example, the common navigation route among the three candidate routes 1, 2, 3 is displayed as the route from the start point to a point D in FIG. 11.

In step S240, the process detects the current position of the vehicle by the position detector 1.

In step S250, the process determines whether the single destination can be determined based on the current position of the vehicle and the plural candidate routes calculated in step S220. For example, the current vehicle position between the point D and a point A in FIG. 11 leads to the determination that the destination is the point A. In the same manner, the current position between a point E and a point B leads to the determination that the destination is the point B, and the current position between the point E and a point C leads to the determination that the destination is the point C. The process repeats steps S240 and S250 when the destination cannot be determined. The process proceeds to step S260 when the destination is determined.

In step S260, the process displays the navigation route to the determined destination.

Yet another modification of the above-described embodiment is that the result of the destination estimation may be outputted together with the estimated travel purpose.

Still yet another modification of the above-described embodiment is that the estimated travel purpose may be used to display information regarding the estimated travel purpose.

FIG. 12 shows a flowchart of the process for controlling information display regarding the travel purpose. The process in FIG. 12 repeats itself at a predetermined interval in parallel with the process in FIG. 6, 9 or 10.

In step S300, the process determines whether the travel purpose is estimated. For example, the process is determined as affirmative when the parallel process executes step S120 (in FIG. 6 and FIG. 10). The process proceeds to step S310 when the travel purpose is estimated (step S300:YES). The process concludes itself when the travel purpose is not estimated (step S300:NO).

In step S310, the process gathers information regarding the estimated travel purpose. The information gathered in this step includes the information of facility or the like in a proximity of the current position of the vehicle and the information regarding the navigation route to the estimated destination. For example, when the estimated travel purpose is shopping, the gathered information includes the shopping facility information, the business hour information of the shops, bargain sale information and the like. The information may be gathered by the transceiver 11 or may be retrieved from stored information in the external memory 9.

In step S310, the process displays the gathered information on the display 10.

Such changes and modifications are to be understood as being within the scope of the present disclosure as defined by the appended claims.

What is claimed is:

1. A navigation system having a travel situation detection function for providing a navigation route of a travel between a start point and an end point comprising:
a storage unit for storing a travel purpose determiner that suitably determines a travel purpose according to a travel situation of a predetermined type having time specificity; and
an inference engine for inferring the end point of the travel based on the travel purpose that results from an application of a detected travel situation by the travel situation detection function to the travel purpose determiner.

2. The navigation system as in claim 1,
wherein the travel purpose determiner determines the travel purpose based on user information having a stationary property in addition to the travel situation.

3. The navigation system as in claim 2,
wherein the travel purpose determiner includes a travel situation node and a user information node as parent nodes of a travel purpose node in Bayesian network model,
the travel purpose determiner includes an end point node as a child node of the travel purpose node in the Bayesian network model, and
the inference engine uses the Bayesian network model stored in the storage unit for determining the end point of the travel.

4. The navigation system as in claim 3 further comprising:
a re-definition facilitator for facilitating re-definition of the Bayesian network model based on the actually detected travel situation and the user information in addition to the travel purpose and the end point of the travel,
wherein a predetermined relationship of the end point of the travel to the travel purpose is employed for re-definition of the Bayesian network model.

5. The navigation system as in claim 1,
wherein the inference engine outputs the determined travel purpose and the determined end point of the travel.

6. The navigation system as in claim 1 further comprising:
a probability engine in the inference engine for determining whether one of a plurality of the candidate end points of the travel is chosen based on a probability of each of the candidate end points of the travel; and
a determination engine in the inference engine for determining the end point of the travel based on calculation of the navigation route from a current position of the vehicle to each of the candidate end points when the one of the plurality of the candidate end points is not chosen based on the probability of the each of the candidate end points,
wherein the inference engine determines the plurality of the candidate end points of the travel for use by the probability engine and the determination engine.

7. The navigation system as in claim 1 further comprising:
a travel information acquisition unit for acquiring information on the travel purpose determined by the travel purpose determiner; and
a travel information output unit for outputting the information on the travel purpose acquired by the travel information acquisition unit.

8. A program for controlling the navigation system as in claim 1, the program stored in the storage unit for use in a computer that is functional as the navigation system comprising a procedure of:
providing a function of the travel purpose determiner; and
providing a function of the inference engine.
